(19) United States
(12) Patent Application Publication
(10) Pub. No.: US 2025/0254706 A1
(43) Pub. Date: Aug. 7, 2025

(54) METHOD FOR PROVIDING COORDINATED TRANSMISSIONS BETWEEN MULTIPLE ACCESS POINTS

(71) Applicant: HUAWEI TECHNOLOGIES CO., LTD., SHENZHEN (CN)

(72) Inventors: Michael MONTEMURRO, Kanata (CA); Stephen MCCANN, Kanata (CA); Arik KLEIN, Giva'at Shmu'el (IL); Shimon SHILO, Kanata (CA); Genadiy TSODIK, Kanata (CA); Oded REDLICH, Kanata (CA); Kwok Shum AU, Kanata (CA)

(73) Assignee: HUAWEI TECHNOLOGIES CO., LTD., SHENZHEN (CN)

(21) Appl. No.: 19/186,819

(22) Filed: Apr. 23, 2025

Related U.S. Application Data
(63) Continuation of application No. PCT/CN2023/077702, filed on Feb. 22, 2023.

(51) Int. Cl. H04W 72/27; H04W 12/06; H04W 72/51

(52) U.S. Cl. CPC H04W 72/27; H04W 12/06; H04W 72/51

(57) ABSTRACT

A method of configuring a multiple Access Points (M-AP) set includes transmitting, by an access point (AP) initiating a new M-AP set, an information element including a plurality of octets. One of the plurality of octets indicates the presence of an extended capabilities octet of the plurality of octets. A bit of the extended capabilities octet indicates if an M-AP Coordinated Transmissions (CT) Basic Service Set (BSS) is enabled for this AP. A method of establishing a multiple Access Points (M-AP) set between APs includes transmitting, by a first AP, a first message advertising an M-AP Coordinated Transmission (CT) Basic Service Set (BSS), receiving, by the first AP, from a second AP, a second message advertising a second M-AP CT BSS, and initiate peering, in response to receiving the first message or the second message, used by an M-AP set including the first AP and the second AP.

### CROSS-REFERENCE TO RELATED APPLICATION

This application is a continuation of International Patent Application No. PCT/CN 2023/077702, filed on Feb. 22, 2023, and titled “Method for Providing Coordinated Transmissions between Multiple Access Points”, the content of which is incorporated herein by reference in its entirety.

### TECHNICAL FIELD

This disclosure pertains generally to the field of wireless communications and in particular to providing wireless connectivity between a set of multiple access points (APs) operating on a common channel.

### BACKGROUND

Wireless Local Area Network (WLAN) systems may operate in unlicensed bands, which means that WLANs operating in overlapping coverage can interfere with each other. There have been proposals for access points (APs) operating in the same coverage area to coordinate transmissions in order to reduce the amount of local interference. Presently, there is work going on in the IEEE 802.11 standards committees to add features and capabilities which allow APs to coordinate transmissions to stations (STAs) while the APs may be overlapping in their coverage.

There exist many challenges in coordinating transmissions by APs when there is overlap in time, space, and frequency that must be solved to provide a robust multi-AP (multiple AP) configuration. This involves the APs communicating between themselves using mechanisms to discover each other, establish connections, to communicate, and to later adjust the transmission parameters. This could be done over wired links, however it is advantageous to for at least some of the communications to take place over the wireless medium.

Therefore, there is a need for methods to configure and manage a group of APs into a set with agreed upon coordination methods and transmission parameters, that obviates or mitigates one or more limitations in the prior art.

This background information is intended to provide information that may be of possible relevance to the present invention. No admission is necessarily intended, nor should be construed, that any of the preceding information constitutes prior art against the present invention

### SUMMARY

Embodiments of the present disclosure generally provide methods and apparatus for providing wireless connectivity between a set of multiple APs (M-AP set), operating on the same channel, to facilitate the establishment of coordinated transmission (CT) agreements among subsets of APs under this M-AP set. Existing IEEE 802.11 base standard mesh networking procedures defining discovery, connection, and communication mechanisms may be adapted and reused for a multiple-AP (M-AP) Coordinated Transmissions (CT) Basic Service Set (BSS) creation. As the existing IEEE 802.11 mesh mechanisms do not include a central entity such as an AP of an Infrastructure BSS, they can be re-used by a set of APs to form an M-AP CT BSS. In these mesh mechanisms, discovery, connection management, security, and communications have already been defined for peering between mesh stations (STAs). The distributed nature of mesh networking may be adapted to provide connectivity between a subset of APs for the purpose of generating CT agreements between subsets of APs operating on the same channel under this M-AP set.

According to an embodiment of the present disclosure, there is provided a method of configuring a multiple Access Points (M-AP) set. The method includes transmitting, by an access point (AP) initiating a new M-AP set, an information element including a plurality of octets. One of the plurality of octets indicates the presence of an extended capabilities octet of the plurality of octets. The extended capabilities octet indicates if an M-AP Coordinated Transmissions (CT) Basic Service Set (BSS) is enabled for this AP.

In further embodiments, the enabling of the M-AP Coordinated Transmissions (CT) Basic Service Set (BSS) is indicated by a bit of the extended capabilities octet.

In further embodiments, the information element is included in a Beacon frame or in a Probe Response frame transmitted in the M-AP CT BSS.

In further embodiments, the Mesh Capability subfield which indicates the presence of the final octet is encoded as a hexadecimal value 0×81.

In further embodiments, the bit is encoded as a 1 to indicate that M-AP CT feature is enabled.

In further embodiments, the information element further includes a Mesh ID and an Authentication Protocol identifier.

In further embodiments, the information element further includes any of a length, an active path selection metric identifier, an active path selection metric identifier, a congestion control mode identifier, a synchronization method protocol identifier, a mesh formation information or Mesh Capability.

In further embodiments, the length subfield has value of 8, the active path selection metric identifier subfield has a value of 254, the active path selection metric identifier subfield has a value of 254, the congestion control mode identifier subfield has a value of 254, the synchronization method protocol identifier subfield has a value of 254, or the mesh formation information subfield has a value of 0.

In further embodiments, the mesh configuration element includes an extended mesh capability sub-field.

In further embodiments, the extended mesh capability sub-field includes the bit which indicates the enabling of the M-AP CT BSS.

In further embodiments, the Mesh Capability subfield comprises any of an accepting additional mesh peerings sub-field, an MCCA supported sub-field, an MCCA enabled sub-field, a forwarding sub-field, an MBCA enabled sub-field, a TBBT adjusting sub-field, a mesh power save level sub-field, or an Extended Mesh Capability Present sub-field.

In further embodiments, the accepting additional mesh peerings sub-field has a value of 1, the MCCA supported sub-field has a value of 0, the MCCA enabled sub-field has a value of 0, the forwarding sub-field has a value of 0, the MBCA enabled sub-field has a value of 0, the TBBT adjusting sub-field has a value of 0, the mesh power save level sub-field has a value of 0, or the Extended Mesh Capability Present sub-field has a value of 1.

According to an embodiment of the present disclosure, there is provided a method of establishing a multiple Access Points (M-AP) set between access points (APs). The method includes transmitting, by a first AP, a first message advertising an M-AP Coordinated Transmission (CT) Basic Service Set (BSS). Also, receiving, by the first AP, from a second AP, a second message advertising a second M-AP CT BSS. Furthermore, initiating peering, in response to receiving the first message or the second message, used by an M-AP set including the first AP and the second AP.

Embodiments further include receiving, by the first AP, from the second AP, a peering open message.

Embodiments further include transmitting, by the first AP, to the second AP, a peering open message.

Embodiments further include provisioning the M-AP set with security credentials.

In further embodiments, the provisioning of the M-AP set includes transmitting, by the first AP, to the second AP, a Mesh Peering Open frame, and receiving by the first AP, from the second AP, a Mesh Peering Confirm frame transmitted by the second AP in response to the second AP receiving the Mesh Peering Open frame.

According to an embodiment of the present disclosure, there is provided a method for an access point (AP) to initiate establishment of a multiple Access Points (M-AP) set or to join an existing M-AP set, where the AP is part of a Multi Basic Service Set Identifier (MBSSID) set. The method includes adding, by the AP, a subelement to a Multi Basic Service Set Identifier (MBSSID) element carried in a Beacon frame or a Probe Response frame transmitted by a transmitted BSSID of the MBSSID set. The subelement includes a Mesh ID element and a Mesh configuration element containing the parameters of an M-AP Coordinated Transmission (CT) Basic Service Set (BSS).

In further embodiments, the subelement corresponds to a non-transmitted BSSID profile subelement. The non-transmitted BSSID profile subelement further includes a non-inheritance element including a list of element IDs. The list of element IDs includes element ID values of the Mesh Configuration element and the Mesh ID element.

In further embodiments, the subelement corresponds to an M-AP CT BSS subelement. The M-AP CT BSS subelement includes the Mesh configuration element, the Mesh ID element, and a MBSSID index list element. The MBSSID index list element includes a list of nontransmitted BSSIDs corresponding to the MBSSID set that are also members of the exiting M-AP set.

In further embodiments, the transmitted BSSID which is a member of the M-AP set, will be indicated as Index 0 in the BSSID index list.

According to an embodiment of the present disclosure, there is provided a method for an access point (AP), which is affiliated with an Access Point Multi-link Device (APMLD) and is operating on a specific link out of a plurality of links, to initiate establishment of a multiple Access Points (M-AP) set on another link of the same APMLD or to join an existing M-AP set on another link of the same APMLD. The method includes adding, by the AP, a first subfield to a STA Control field of a Per-STA Profile subelement included in a Basic multi-link element carried in Beacon or in a Probe Response frame. The first subfield includes an indication that M-AP Coordinated Transmission (CT) Basic Service Set (BSS) information is present in a STA Info field of the Per-STA Profile subelement. Also, adding, by the AP, further elements to the STA Info field of the Per-STAProfile subelement, specifically, includes a Mesh ID element and a Mesh configuration element containing the parameters of the M-AP CT BSS.

Embodiments further include receiving, by the AP, a Beacon frame or Probe Response frame including the MBSSID element, where the MBSSID element contains the subelement. Also, extracting, by the AP, from the subelement, a profile of the M-AP set, where the M-AP set is capable of M-AP CT operation.

According to an embodiment of the present disclosure, there is provided a method of configuring a Medium Access Control (MAC) layer by a Station Management Entity (SME). The method includes receiving, by the SME, from an external management entity, a multiple AP (M-AP) Coordination Transmission (CT) Basic Service Set (BSS) configuration parameters.

In further embodiments, the external management entity is a WLAN controller device or a Multi access point (AP) controller.

Embodiments further include receiving, by a MAC Layer Management Entity (MLME), from the SME, a request primitive including a mesh ID associated with the M-AP CT BSS, an authentication protocol identifier of the M-AP CT BSS, or credential information of the M-AP CT BSS.

Embodiments further include sending, by the MLME, to the SME, a confirmation primitive including a status of the configuration request.

According to an embodiment of the present disclosure, there is provided a method of configuring a multiple Access Points (M-AP) set. The method includes monitoring, by an external management entity, a first multiple AP (M-AP) Coordination Transmission (CT) Basic Service Set (BSS). Also, sending, by the external management entity, to an AP participating in the first M-AP CT BSS, a second M-AP CT BSS configuration parameters instructing the AP to become associated with the second M-AP CT BSS.

According to an embodiment of the present disclosure, there is provided a method of configuring a multiple Access Points (M-AP) set. The method includes receiving, by an access point (AP) participating in a first multiple AP (M-AP) Coordination Transmission (CT) Basic Service Set (BSS), from an external management entity, a second M-AP CT BSS configuration parameters set. Also, in response to receiving the second M-AP CT BSS configuration parameters set, joining, by the AP, to the second M-AP CT BSS.

Embodiments further include discovering, by the AP, a second M-AP CT BSS, and joining, by the AP, the second M-AP CT BSS.

In further embodiments, the external management entity is a WLAN controller of a Multi access point (AP) controller.

According to an embodiment of the present disclosure, there is provided apparatus and systems configured to implement all or part of any of the methods as described herein. Apparatus may include electronic or computing devices as found in wireless infrastructure including access points, base stations, management entities, etc. Multiple apparatus may be combined to form all or part of a system implementing the methods described herein.

According to an embodiment of the present disclosure, there is provided computer readable media including software instructions or data implementing all or part of any of the methods as described herein.

Embodiments have been described above in conjunctions with aspects of the present disclosure upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1 provides an example for WLAN with M-AP set, according to embodiments of the present disclosure.

FIG. 2 illustrates the steps required before conducting a Coordinated Transmission (CT), according to the prior art and embodiments of the present disclosure.

FIG. 3 provides an example of M-AP Coordinated transmission behavior in WLAN (where only part of the APs support the M-AP CT), according to the prior art and embodiments of the present disclosure.

FIG. 4 provides an example of an M-AP CT BSS discovery and peering method, according to embodiments of the present disclosure.

FIG. 5 provides a mesh configuration element for an M-AP CT BSS with a mesh capability sub-field and an extended mesh capability sub-field, according to embodiments of the present disclosure.

FIG. 6a provides an example for the indication of an M-AP CT BSS as part of a non-transmitted profile of the MBSSID element, according to embodiments of the present disclosure.

FIG. 6b provides an example for the indication of an M-AP CT BSS as a new MBSSID sub-element, according to embodiments of the present disclosure.

FIG. 6c provides an example of optional subelement IDs for multiple BSSID element, according to embodiments of the present disclosure.

FIG. 6d provides an example of including Mesh Configuration and the Mesh ID elements in a Link Info field/Per-STA Profile subelement) of a Basic Multi-Link Element, according to embodiments of the present disclosure.

FIG. 7 illustrates a flow diagram of M-AP CT BSS discovery and peering, according to embodiments of the present disclosure.

FIG. 8 illustrates an initial M-AP CT-BSS network topology during dynamic configuration, according to embodiments of the present disclosure.

FIG. 9 provides an updated M-AP CT-BSS network topology during dynamic configuration, according to embodiments of the present disclosure.

FIG. 10 illustrates a generic block diagram of a communication apparatus of an AP within an M-AP set, according to embodiments of the present disclosure.

It will be noted that throughout the appended drawings, like features are identified by like reference numerals.

### DETAILED DESCRIPTION

Embodiments of the present disclosure facilitate the use of multiple APs organized in a Multi-AP (M-AP) Coordinated Transmissions (CT) Basic Service Set (BSS). The term Multi-AP is synonymous with Multiple APs. The existing IEEE 802.11 base standard mesh networking procedures defining discovery, connection, and communication mechanisms may be adapted and reused for M-AP CT BSS creation, and management. APs that use the same channel and have an overlapping bandwidth (BW) may form a mesh network to create an M-AP set. A subset of APs within the M-AP CT BSS may establish Coordinated Transmissions (CT) agreement, which may also be referred to as simply “coordinated agreement,” that allow these APs to apply the coordinated transmission of their BSS without interfering with each other.

WLAN systems may operate in unlicensed bands, which in some cases leads to individual WLANs operating on the same channel and in overlapping coverage thus, interfering with each other in time, space, frequency, etc. Embodiments provide features and capabilities which allow APs to coordinate transmissions to other OBSS APs and their associated stations (STAs) even with overlapping BSS coverage.

Embodiments organize wireless devices in Basic Service Sets (BSSs) which is an IEEE 802.11 definition of a set of wireless station devices/entities that can communicate with each other either directly or through an Access Point (in case of an Infrastructure BSS). The BSS is the basic network building block of an IEEE 802.11 WLAN. When a wireless device is part of mesh BSS (MBSS), i.e., a mesh network, which does not support the functionalities of an Infrastructure BSS, the wireless device may attempt to discover other mesh wireless station devices/entities and transmit beacon frames advertising the MBSS. Other mesh wireless station devices/entities may then use traditional IEEE 802.11 discovery mechanisms such as passive scanning (listening for Beacon frames), or active scanning (transmitting Probe Request and receiving Probe Responses). A “mesh profile” identifies the MBSS and may be included in Beacon and Probe Request/Response frames. The mesh profile includes a “Mesh ID” (e.g., an information element in management frames), which identifies an instance of an MBSS.

A mesh peering is a distributed, non-hierarchical, and non-exclusive agreement between two mesh wireless devices to establish a communication state and may include authentication and other security methods to be used between wireless devices. Each mesh wireless device may manage its peerings with other mesh wireless devices. Various modes of mesh peering may be using including secured peering (using Authenticated Mesh Peering Exchange (AMPE)), and unsecured peering (using Mesh Peering Management (MPM)). As part of the peering process, a capability check may be performed by profile matching and each peering has attributes that must be agreed upon. It should be noted that each peer wireless device may make an offer of attributes to use for a potential peering and each peer wireless device must then confirm the agreed-upon attributes that define the peering. After each side has offered and confirmed agreement, the peering is established. Each peer wireless device can initiate a peering and both sides can initiate the peering simultaneously. However, in some cases, it is possible for just one peer wireless device to be a responder.

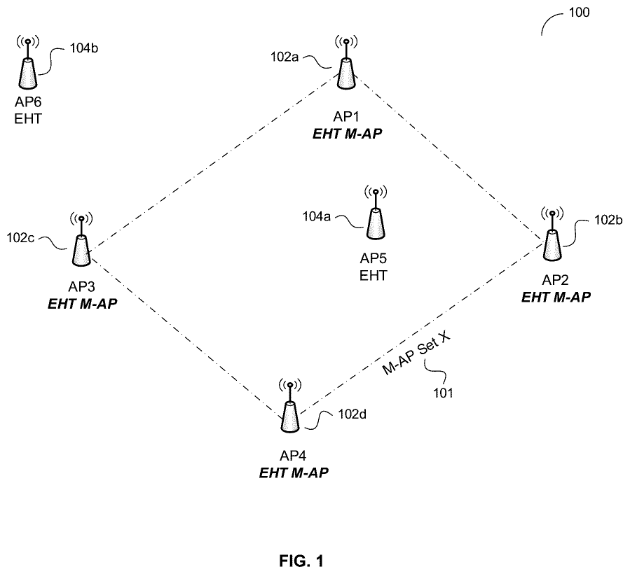

FIG. 1 illustrates an embodiment including a WLAN 100 where APs 1-4 (102a-102d) are members of an M-AP set that may also participate in coordinated transmissions (CTs), while AP 5 and 6 (104a and 104b) do not support the M-AP coordinated transmission. Multi AP (M-AP) coordinated transmission is a mechanism where a group of OBSS (Overlapping BSS) APs, which share a common BW on the same operating channel, coordinate parameters in order to initiate multiple frame exchanges within a time period known as a transmission opportunity (TXOP). As referred to herein, OBSS APs that indicate their capability to participate in CT may be referred to as APs within an M-AP set. The group of APs that indicates its capability to cooperate and perform coordinated communications is called an M-AP Set. Each AP within the M-AP set shares a common BW on the same operating channel and is associated with a number of STAs in an infrastructure BSS. Each AP illustrated in FIG. 1 may have overlapping coverage and may create interference with each other under particular conditions.

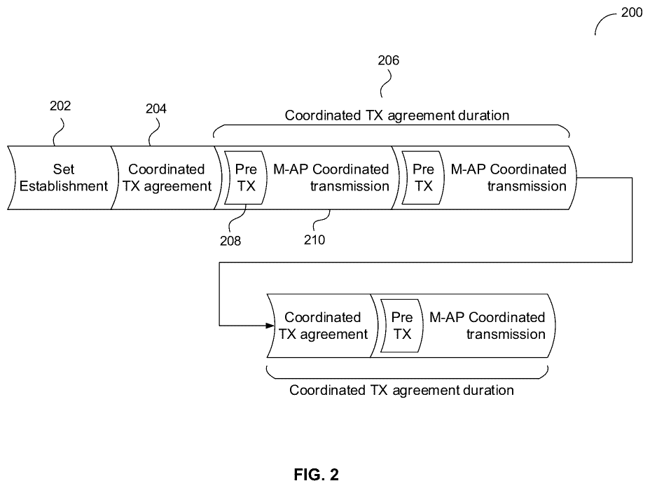

FIG. 2 illustrates a timeline and process 200 for conducting coordinated transmission (CT) between a group of APs, which share a common BW on the same operating channel, for example APs 102a to 102d in FIG. 1, according to an embodiment. In the process 200, it may be assumed that part of the transmission parameter values for coordinated transmission 210 may change between transmission opportunities (TXOPs) 206, and therefore the APs participating in a coordinated transmission agreement 204 may communicate with each other to negotiate the parameter values. Examples of CT parameters include the list of APs, the coordination scheme, and radio resource allocation. In step 202 the set of APs, which share a common BW on the same operating channel participating in the M-AP CT BSS may be established. In step 204, the subset of APs within the M-AP set may negotiate a Coordination (transmission) Agreement. This Coordination agreement allows a subset of APs within the M-AP set to perform coordinated transmissions over several TXOPs up to the duration 206, under the same CT agreement. Many of the CT agreement parameters negotiated in the establishment of the CT agreement do not require updating and only those that are required by network dynamics are actually updated per each TXOP. An announcement frame based on the CT agreement may be introduced in a pre-transmission period (Pre-TX) 208, allowing the AP that obtained the TXOP to indicate specific coordination parameters of the current TXOP to the other APs operating under the same CT agreement that will participate in the coordinated transmission in the current TXOP. Once CT parameters are exchanged or updated, M-AP coordinated transmission (CT) 210 may occur.

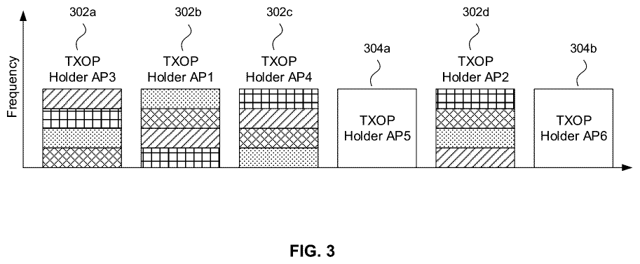

Embodiments that implement CT between multiple APs may make use of terminology introduced by the IEEE 802.11 be task group. An Extremely High Throughput (EHT) AP that obtains a TXOP and initiates a Multi-AP coordination may be referred to as a Sharing AP. An EHT AP which is coordinated for the Multi-AP coordinated transmission by the Sharing AP may be referred to as a Shared AP. In a WLAN which supports coordination between APs, the TXOP holder may share resources with other APs within the same M-AP set that are operating under the same Coordination agreement. The TXOP holder may be able to inform other APs that may participate in the coordination transmission that occurs in the current TXOP about proposed coordination parameters. FIG. 3 illustrates TXOP holders 302a through 302d and 304a and 304b. TXOP holders 304a and 304b correspond to AP5 104a and AP6 104b which do not participate in coordinated transmissions. TXOP holders 302a through 302d correspond to AP1 through AP4 (reference 102a through 102d) are configured for coordinated transmissions as disclosed in embodiments described herein and share the communications resources of holders 302a-302d.

Embodiments facilitate the communication between a plurality of APs which share a common BW on the same operating channel, to include the establishment of an M-AP set or a Coordination agreement. Communications between APs may be independent of the links that provide network access to other WLAN devices such as STA in communication with an AP.

Though some communication between the APs can be done over wired links, embodiments provide the advantage that some of the communications may take place over the wireless medium. To perform Coordinated Transmissions (CT), multiple APs which share a common BW on the same operating channel and optionally operating in the same coverage area, may establish communications to allow a long-term coordinated transmission with enough flexibility to change coordinated transmission agreement parameters as required. APs that want to establish in an M-AP set for the purpose of CT may perform provisioning and discovery of AP peers, establishment of communications between the peer APs in a secure manner, independent of operational network access of STAs, or management and reconfiguration of a connection state between AP peers.

Embodiments provide methods to establish an M-AP CT BSS as a basis for a set of multiple APs (M-AP set), operating on the same channel with a common BW. Embodiments may adapt mesh networking discovery, connection, and communication mechanisms from the IEEE 802.11 base standard for Multi-AP (M-AP) Coordinated Transmissions (CT) Basic Service Set (BSS) creation. As the existing IEEE 802.11 mesh mechanism does not include a central entity such as the AP role in an infrastructure BSS, these mechanisms can be re-used by a set of APs to form an M-AP CT BSS. Mechanisms for discovery, connection management, security, and communications already been defined for peering between mesh STAs may be adapted for peering between APs within an M-AP CT BSS. The distributed nature of mesh networking may be adapted to provide connectivity between a subset of APs for the purpose of generating a CT agreement between these APs which are operating on the same channel with a common BW.

An M-AP CT BSS is a special variant of a Mesh Basic Service Set (MBSS) where the peer APs form a multi-AP set. The Mesh ID of the IEEE 802.11 base standard may be used to identify the M-AP CT BSS for the purpose of frame exchange among AP within an M-AP set. AP members of the M-AP set that are operating in the same M-AP CT BSS and can establish a CT agreement in order to apply one or more coordinated transmissions between these APs.

In embodiments, an AP participating in an M-AP CT BSS may follow the mesh requirements for advertisement, discovery, authenticated peering, security, MBSS synchronization, support for additional mesh peerings, broadcast and triggered UL. Criteria may be established as to when an AP may participate or not. For example, embodiments may be most effective when APs of an M-AP set are within a minimal range of each other, and therefore APs may elect to peer only with other APs of the M-AP set based on a proximity indication. An example of a proximity indication may be if a Received Signal Strength Indicator (RSSI) measured from received Beacons frames of Probe Responses frames is above an RSSI threshold, for example, −62 dBm. The participating AP need not follow the mesh requirements for path selection, hybrid wireless mesh, interworking with the distribution system (DS) or bridging, power-save, or MCCA as stated in the IEEE 802.11 base standard.

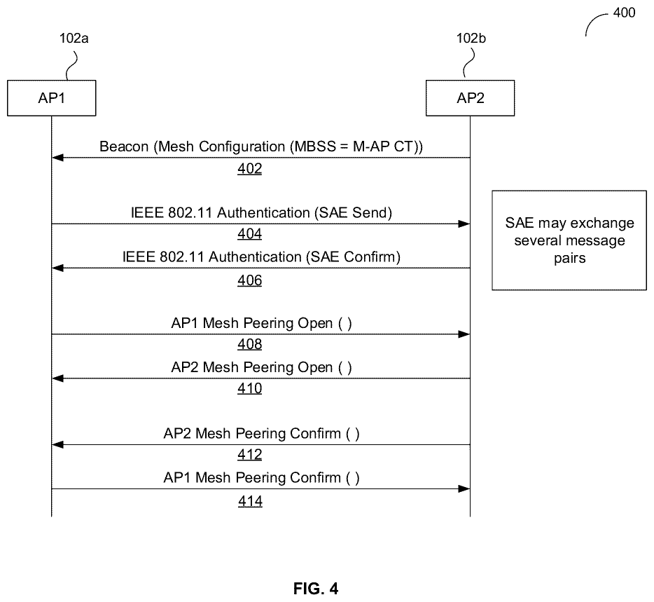

FIG. 4 illustrates frame flow 400 that may be used in embodiments to establish a peering relationship between any pair of APs in an M-AP CT BSS which is based on the WLAN mesh peering protocol. The APs may advertise an M-AP CT BSS in Beacon frames 402 using an “M-AP CT BSS” indicator. Existing IEEE 802.11 authentication protocols for mesh networking, such as Simultaneous Authentication of Equals (SAE) messages 404 and 406, may also be used between AP1 102a and AP2 102b. The peering messages Mesh Peering Open 408 and 410 and Mesh Peering Confirm 412 and 414 may be transmitted and received between candidate APs within the M-AP CT BSS to establish connectivity. Each AP in an M-AP set completes peering with each other AP in the group in order to participate and communicate with other group APs. Once the peering is complete, AP members of an M-AP CT BSS exchange management frames to facilitate coordinated transmissions. The management frame format follows requirements for both individually addressed and group addressed management frame transmissions in an MBSS. An AP may terminate its M-AP CT BSS connection to another AP peer by transmitting a Mesh Peering Close frame.

The embodiment shown in FIG. 4 may be used to allow peer APs to advertise M-AP CT BSS capability in a distributed manner in order to initiate frame exchange between peer APs within the M-AP set.

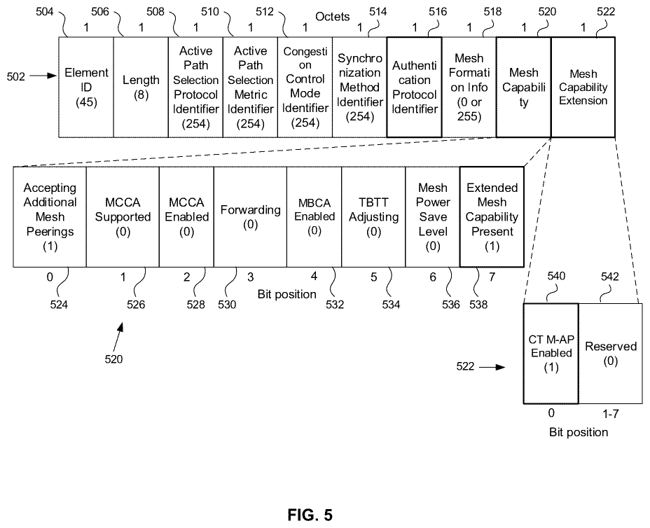

With reference to FIG. 5, embodiments may utilize existing Beacon frames and Probe Response frames with a modified mesh capability field to advertise an M-AP CT BSS. An M-AP CT BSS may be advertised by adapting existing Beacon frames or Probe Response frames used for mesh BSSs. Beacon frames or Probe Response frames used for mesh BSS configuration include a Mesh ID and an authentication protocol identifier (as specified in the IEEE 802.11-2020 standard). FIG. 5 illustrates how a mesh configuration element 502 used in Beacon frames or Probe Response frames may be modified to advertise an M-AP CT BSS. A Beacon frame or a Probe Response frame transmitted in an M-AP CT BSS includes various elements:
a Mesh ID element, restricted to 2 octets,
a Mesh Configuration element 502,
,
a Beacon Timing element (optionally present),
, and
a Mesh Channel Switch Parameters element (optionally present).

Mesh configure element 502 includes a number of fields. In embodiments, some fields may be set to the values indicated in parenthesis. Fields with a suggested value set to a value of 254 may be used to indicate that the field is not applicable when this element is carried in Beacon and Probe Response frames transmitted in an M-AP CT BSS.
Element ID 504 (suggested value=45)
Length 506 (suggested value=8)
Active Path Selection Protocol Identifier 508 (suggested value=254)
Active Path Selection Metric Identifier 510 (suggested value=254)
Congestion Control Mode Identifier 512 (suggested value=254)
Synchronization Method Identifier 514 (suggested value=254)
Authentication Protocol Identifier field 516 (suggested value=a valid value as defined in IEEE 802.11-2020)
Mesh Formulation Info field 518 (suggested value of 0 or 255)
Mesh Capability field 520
Mesh Capability Extension field 522

The Mesh Capability field 520 may be one octet in length with the field's eight bits defines as defined as follows:
B1: Accepting Additional Mesh Peerings 524, may be set to 1 to advertise acceptance of mesh peerings for the M-AP CT BSS.
B1: MCCA Supported 526 (suggested value=0)
B2: MCCA Enabled 528 (suggested value=0)
B3: Forwarding 530 (suggested value=0)
B4: MBCA Enabled 532 (suggested value=0)
B5: TBBT Adjusting 534 (suggested value=0)
B6: Mesh Power Save Level 536 (suggested value=0).
B7: Extended Mesh Capability Present 538 may be set to 1 to advertise that the Mesh BSS is an M-AP CT BSS, or indicate that there is an additional Mesh Capability Extension field 522 present. In the latter case, the M-AP CT BSS would be advertised in the Mesh Capability Extension field 522 field.

The Mesh Capability Extension field 522 may be one octet in length and used when the Extended Mesh Capability Present bit 538 is set to 1.
B0: CT M-AP Enabled 540 (suggested value=1 if enabled)
B1-7: Reserved 542, and may be set all to 0.

In other words, embodiments may include the Mesh Configuration element 502 of FIG. 5 with suggested fixed values for the mesh configuration parameters shown in parenthesis. There is a single reserved bit 538 (bit 7, Extended Mesh Capability Present field) in the Mesh Capability field 520. If the reserved bit 538 is not used to advertise the M-AP CT BSS, then the length of the Mesh Configuration element 502 is seven octets and the Extended Mesh Capability field 522 is not required. If the reserved bit 538 is used to advertise that the Extended Mesh Capabilities field 522 is present (to preserve the extensibility of the Mesh Configuration element 502), then the reserved bit 538 may be set to 1 to indicate that there is an Extended Mesh Capability field 522 present.

In embodiments, a subset of APs, such as AP1-AP4 (references 102a through 102d) in FIG. 1, that want to establish an M-AP set should form an M-AP CT BSS. In this case, an initiator AP, such as AP1 102a, may invite other responder APs in range, to participate in the M-AP set AP1 102a initiates. The initiator AP (e.g., AP1 102a) begins transmitting beacon frames advertising the M-AP CT BSS. A responder AP, such as any of AP2 102b, AP3 103c, or AP4 102d may join the M-AP CT BSS and establish a M-AP set. It may be assumed that the APs participating in the M-AP set are provisioned (for example, by using the method illustrated in FIG. 4) with a Mesh ID and, if required, security credentials to securely complete peering. Once a responder AP receives a Beacon frame or Probe Response frame with the M-AP CT BSS advertised, it may begin advertising the M-AP CT BSS using the same Mesh ID value and Mesh configuration element included in the Received Beacon frame or Probe Response frame and initiate peering with the initiator AP and all responder APs in range (provided that each of them start advertising the M-AP CT BSS using the same Mesh ID value and Mesh configuration element as this responding AP). This embodiment may allow peer APs, such as those illustrated in FIG. 1, to take advantage of existing discovery and peering mechanisms used for mesh networks (e.g., with capability values illustrated in FIG. 5 and described in the description of FIG. 5) to establish the M-AP set using an M-AP CT BSS.

Embodiments may include both M-AP CT BSSs and infrastructure BSSs operating independently, which could lead to an AP that supports multiple types of BSSs, and even an additional MBSS, transmitting separate Beacon frames for each type of BSS. In embodiments, M-AP CT BSS services may be operated by APs pertaining to the same M-AP set, and an M-AP CT BSS may be advertised in Beacon frames being transmitted by each AP for its infrastructure BSS.

In case that any of the APs, that wants to initiate an M-AP set or join an existing M-AP set, is part of Multi BSSID (MBSSID) set, the M-AP CT BSS parameters may be added as a subelement in a Multi BSSID (MBSSID) element (for example as transmitted as part of an infrastructure BSS protocol) carried in a Beacon frame transmitted by the transmitted BSSID of the Multi BSSID set.

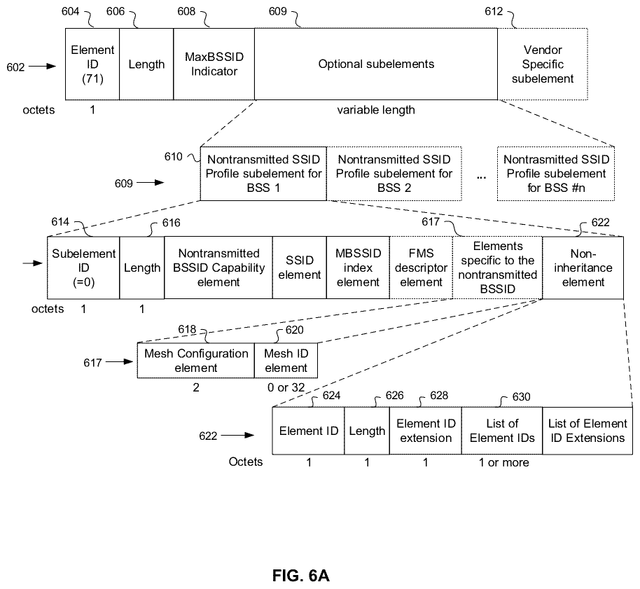

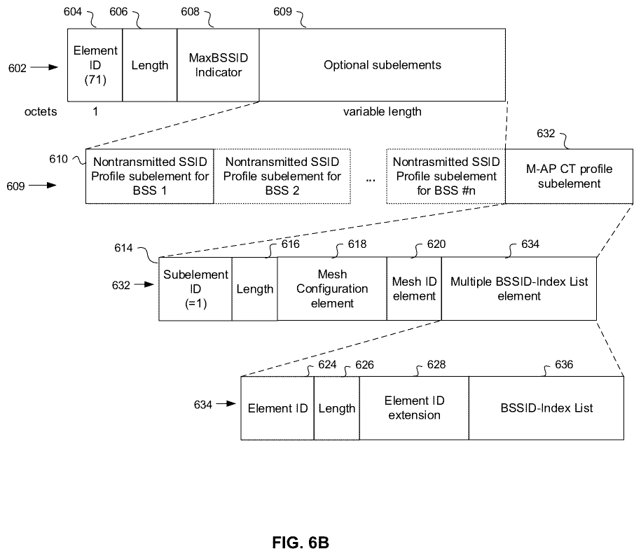

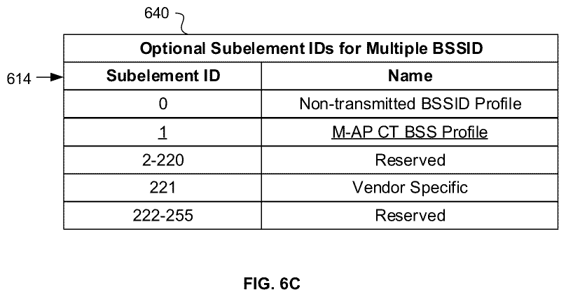

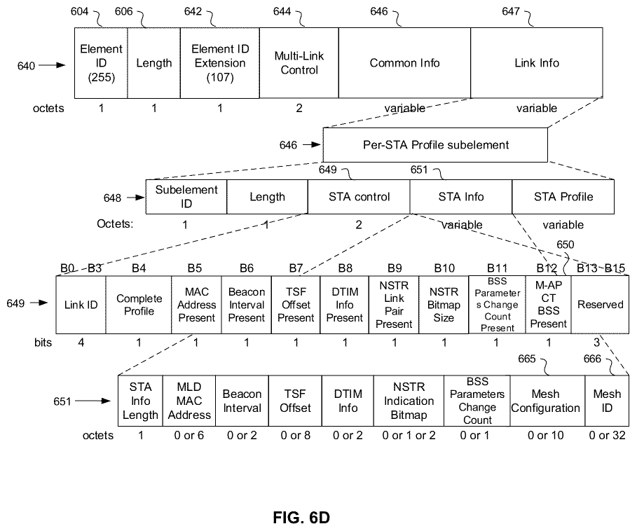

In embodiments, an AP that is configured to join a M-AP CT BSS may advertise a Mesh Configuration element and a Mesh ID element in a Beacon frame or in a Probe Response frame to facilitate M-AP CT BSS discovery. FIG. 6a and FIG. 6b illustrate two methods of using the MBSSID (Multi-BSSID) element 602 to advertise an M-AP CT BSS.

With reference to FIG. 6a, an existing nontransmitted BSSID profile subelement which is included in the Multi BSSID element may be extended to include the Mesh Configuration element 618 and the Mesh ID element 620 in the corresponding nontransmitted BSSID. The Mesh Configuration element 618 and the Mesh ID element 620 may be included in the nontransmitted BSSID profile subelement only if the transmitted BSSID is not part of the M-AP set. In addition, if the transmitted BSSID is not included in the M-AP set, the List of Element IDs (contained in the Non-Inheritance element 622 of the nontransmitted BSSID profile subelement 610) should include the element ID values of the Mesh Configuration element 618 and the Mesh ID element 620.

An MBSSID element 602 includes the following elements:
Element ID 604 of 1 octet (suggested value=71)
Length 606
MaxBSSID Indicator 608
Optional subelements of variable length 609
Vendor Specific subelement 612

The optional subelements 609 may include one or more nontransmitted SSID profile subelements for different BSSs 610. Each nontransmitted SSID profile subelement for specific BSS within the multi BSSID set 610 may include the following element:
Subelement ID 614 of 1 octet (suggested value=0)
Length 616
Elements specific to the nontransmitted BSSID 617
Non-inheritance element 622

The Elements specific to the nontransmitted BSSID 617 may further include the required mesh configuration element 618 and the mesh ID 620.

The Non-inheritance element 622 includes an element ID 624, a length 626, an element ID extension 628, a list of element IDs 630, and a list of element ID extensions.

With reference to FIG. 6b, in embodiments, an M-AP CT profile subelement 632 may be defined as a new subelement of the multiple BSSID element 602. As illustrated in the table of FIG. 6c, a subelement ID 614 of value 1 may be used to indicate an M-AP CT BSS profile. The M-AP CT profile subelement 632 may include:
Mesh Configuration element 618
Mesh ID element 620
Multiple BSSID-Index List element 634

The Multiple BSSID-Index List element 634 may include a list of all nontransmitted BSSIDs that are members of the MBSSID set and are also members of the M-AP set. In this embodiment, the Mesh Configuration element 618 and the Mesh ID element 620 are included only in the M-AP CT profile subelement 632. If the transmitted BSSID is also a member of the M-AP set, the BSSID Index list shall include Index 0. The existing nontransmitted BSSID Profile remains unchanged from other embodiments.

Embodiments may include adding the M-AP CT BSS as a subelement of the Multi BSSID (MBSSID) element defined in existing networking standards such as IEEE 802.11. This profile will be ignored by non-AP STAs (i.e., stations that are not access points) and will be parsed only by APs supporting the M-AP coordinated transmission mechanism as described herein.

In embodiments, a Mesh Configuration element and a Mesh ID element advertising the M-AP CT BSS may be included in Beacon frames or Probe Response frames, either as a profile in the MBSSID element, a standalone element, or in a Common Info field of the Multi-Link element. The MBSSID element may be carried in a Beacon frame or a Probe Response frame with the parameters of the M-AP CT included in subelements of an MBSSID element.

An AP configured to join M-AP set may scan for an M-AP CT BSS in Beacon frames or Probe Response frames transmitted in infrastructure BSS or in case of Multi BSSID in nontransmitted BSSID profiles or in M-AP CT BSS Profile included in the MBSSID element, to discover a peer AP for M-AP CT operation.

Concurrently, if an AP does not discover an M-AP CT BSS advertised in the infrastructure BSS Beacon frames of peer APs, it may add the M-AP CT BSS in a Beacon frame it transmits, to begin advertising the M-AP CT BSS itself. In case that AP is a nontransmitted BSSID in a multi BSSID set, the transmitted BSSID should add the M-AP CT BSS to the nontransmitted BSSID profile subelement or to the M-AP CT BSS Profile subelement included in the MBSSID element carried in the Beacon frame or Probe Response frame. Alternatively, all AP's participating in M-AP CT BSS discovery process may include the M-AP CT BSS in Beacon frames and Probe Response frames to facilitate faster discovery.

With reference to FIG. 6d, in embodiments, in case of multi-link operation (MLO), M-AP CT BSS information of an AP which is affiliated with the same AP MLD as the current (reporting) AP may be included in a STA Info field 651 of the Per-STAProfile subelement 648 included in a Basic multi-link element 640, for example a multi-link element as defined in the IEEE 802.11 TG be specification. A basic multi-link element 640 includes the following fields:
Element ID 604 (suggested value=255)
Length 606
Element ID Extension 642 (suggested value=107)
Multi-Link Control 644
Common Information 646 of variable length
Link Information 648 of variable length

The STA Control field 649 of the Per-STAProfile subelement 648 included in the Link Info field 647 of the Basic Multi link element 640 may include an M-AP CT BSS Info Present subfield 650. The STA Info field 651 may include a Mesh Configuration element 665 and Mesh ID element 666.

In summary, to advertise the M-AP CT BSS, the AP needs to include the Mesh Configuration and the Mesh ID elements in Beacon or Probe Response frames. In the case of a nontransmitted BSSID within a Multi BSSID set, the transmitted AP may include these elements either in the nontransmitted BSSID Profile subelement or in the M-AP CT BSS subelement included in the MBSSID element. In the case of Multi link operation, the current AP may advertise the M-AP CT BSS of other affiliated APs that are operating on other links of the same MLD.

Referring again to FIG. 6a through 6d, in cases where the M-AP CT BSS is defined by an AP that is included as a nontransmitted BSSID in an MBSSID set, embodiments may provide a new mechanism for an AP to listen for a peer AP that is advertising an M-AP CT BSS profile. (In this embodiment, an MBSSID set contains a set of non-transmitted BSSIDs advertised in a Multi-BSSID element that is included in the Beacon and Probe Response frames that are transmitted by a transmitted BSSID of this set.) In addition, it may lead to a decrease in the number of Beacon and Probe Response frames transmitted, thus utilizing efficiently the medium time available for data frame exchange. In embodiments the Mesh Configuration element 618 may have the same format as the Mesh Configuration element 502 of FIG. 5.

In case that the M-AP CT BSS is described in an M-AP CT subelement, it may include a sub element ID 614, a length 616, a Mesh Configuration element 618, and a Mesh ID 620 and Multiple BSSID-Index List element 634. In embodiments the Mesh Configuration element 618 may have the same format as the Mesh Configuration element 502 of FIG. 5

Note that in embodiments, if an AP that is willing to join an M-AP set, does not detect in a Beacon frame or Probe Response frame it receives, which include a MBSSID element an M-AP CT BSS non-transmitted BSSID profile in a non-transmitted BSSID Profile or an M-AP CT subelement, it can then start transmitting one itself, starting the creation of a new M-AP CT BSS for the establishment of M-AP set.

In embodiments, an M-AP CT BSS may be configured in the Medium Access Control (MAC) layer via a Station Management Entity (SME). The SME may receive the M-AP CT BSS configuration via an external management entity such as a WLAN controller or multi-AP controller, as may be done in other networking protocols such as in Wi-Fi Easy Mesh. The Configuration parameters are conveyed to the MAC layer using a MAC sublayer management entity (MLME) primitive that may be used to configure an M-AP CT BSS. Embodiments may include primitives such as an MLME-M-AP-CT-BSS-CONFIG.request (mesh-ID, auth-proto-id, credential-info, Mesh Configuration) primitive, or an MLME-M-AP-CT-BSS-CONFIG.confirm (status) primitive. With these primitives, “mesh-ID” may refer to the mesh-ID element for the M-AP CT BSS, “auth-proto-id” may refer to the Authentication Protocol Identifier for the M-AP CT BSS, “credential-info” may refer to the credential information for the M-AP-CT-BSS based on the value of the Authentication Protocol Identifier, Mesh Configuration may refer to the Mesh Configuration element and “status” may refer to the status code for the request and have at least the values of SUCCESS or FAIL.

In embodiments, existing primitives already defined in IEEE 802.11 standards, such as an MLME-MESHPEERINGMANAGEMENT primitive may be used by an SME to manage the connectivity state for an AP in an M-AP CT BSS. Embodiments allows an interface to be defined within an AP, to allow an external management entity to control the creation of an M-AP CT BSS.

In embodiments, functionality of existing MBSS mechanisms from other standards may be used to form an M-AP CT BSS. APs that want to establish an M-AP set which transmit Beacon frames may advertise an M-AP CT BSS in a Beacon frame or Probe Response frame, such as that inclusion of the MBSS element within a Beacon frame. An AP that wants to join an existing M-AP CT BSS may discover and peer with its neighbor APs which are operating on the same channel and have a common BW and establish a security association (SA) which may include the following IEEE 802.11 security keys: PMKSA, PTKSA, GTKSA. CT APs may be configured by an external management entity for the M-AP CT BSS, as described herein. APs that want to establish a secured M-AP set may use an authenticated mesh peering exchange (AMPE) to establish a SA for a secured peering. Within AMPE, SAE may be used as an authentication protocol within IEEE 802.11 Authentication frames. Mesh peering may be used to establish the AP-AP links.

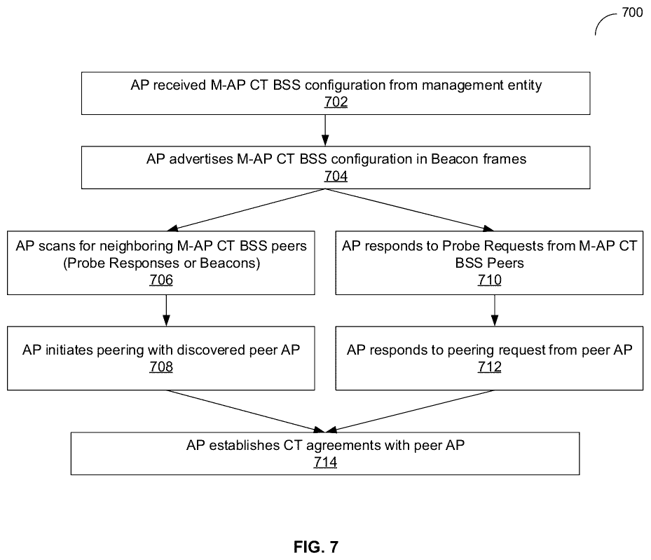

With reference to FIG. 7, method 700 starts in step 702 when an AP receives an M-AP CT BSS configuration from a management entity such as an SME. In step 704, the AP may advertise the M-AP CT BSS parameters which may be done in Beacon frames. If the AP pertains to MBSSID set and is corresponding to the nontransmitted BSSID, the transmitted BSSID of this set shall include the M-AP CT BSS parameters in the Beacon frame it transmits. Then two sets of actions may occur. One when the AP scans for peers and responds appropriately, and another when the AP receives probe request and then responds to received peering requests. In step 706, the AP scans for neighboring APs which pertain to the same M-AP CT BSS, which their parameters may be contained in probe response frames or beacon frames transmitted by these neighboring APs. In step 708, the AP may initiate peering with any peer APs discovered in step 706 with the same M-AP CT BSS profile. In step 710, the AP may respond to probe request frames from any neighboring APs. Then in step 712, the AP may respond to any consecutive peering request received from these neighboring APs in step 710. After both step 708 and step 712, the AP is able to establish CT agreements with any of the peer APs from step 708 or step 712.

In embodiments, APs may be provisioned to discover and establish a peering with other APs that are members in the same M-AP CT BSS and this provisioning may be done by an external (M-AP) management entity which could reside within a WLAN controller or Multi-AP controller (such as used in Wi-Fi Easy Mesh). As this M-AP management entity may monitor the overall network performance, it can dynamically change the M-AP CT BSS configuration to add or remove APs to form different M-AP groups. If an AP receives a new configuration from an M-AP management entity, it may be configured to disconnect from its current M-AP CT BSS, discover, and join a new M-AP CT BSS. It is also possible to split an existing M-AP CT BSS into smaller M-AP CT BSSs with different Mesh profiles and then dynamic re-configuration can be achieved by the peer APs themselves, without the assistance of the M-AP management entity.

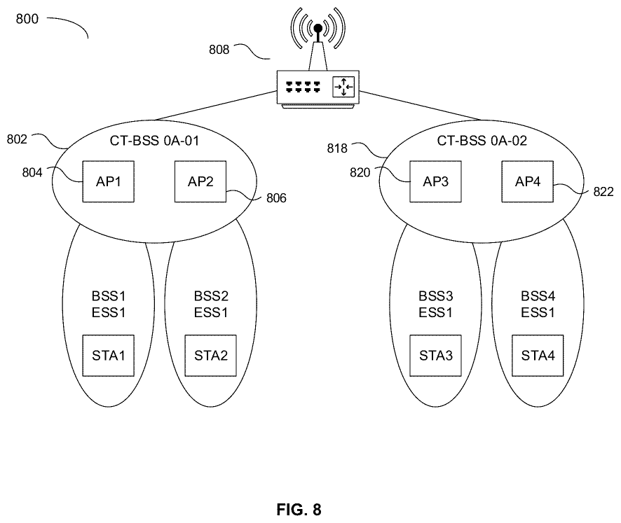

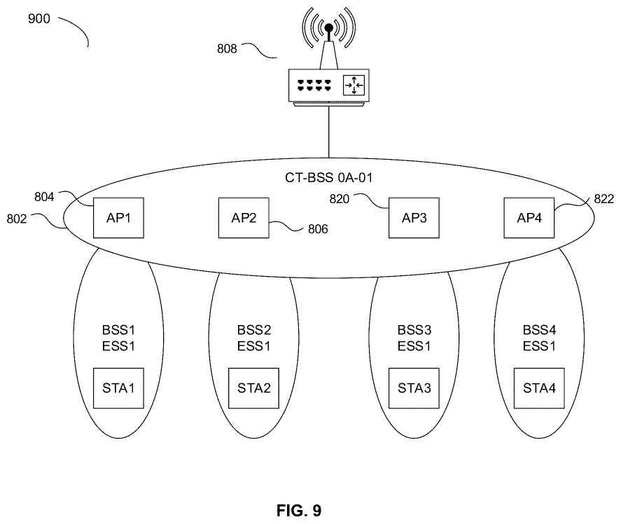

With reference to the topology 800 illustrated in FIG. 8, Network Controller element 808 provides network access external to topology 800 and 900. One M-AP CT BSS, referred to as CT-BSS 0A-01 802 includes AP1 804 and AP2 806. A second M-AP CT BSS, referred to as CT-BSS 0A-02 818 includes AP3 820 and AP4 822. In the case that a wireless environment change occurs, the change may trigger an M-AP Management entity to update the configurations. In FIG. 9, the M-AP Management entity changes the M-AP CT BSS configuration for AP3 820 and AP4 822. AP3 820 and AP4 822 apply the new configuration and peer with AP1 804 and AP2 806 in the same CT-BSS, CT-BSS 0A-01 802, which has a mesh ID, 0A-01.

The ability of embodiments to modify and reuse existing mesh network protocols and data structures provides the technical benefit of easing implementation into existing WLAN systems and methods.

It will be understood by persons having skill in the art that element, field, and bit encodings may be modified and changed in a consistent, standardized manner to enable the design and manufacture of compatible wireless systems and protocols without deviating from the teachings as described herein.

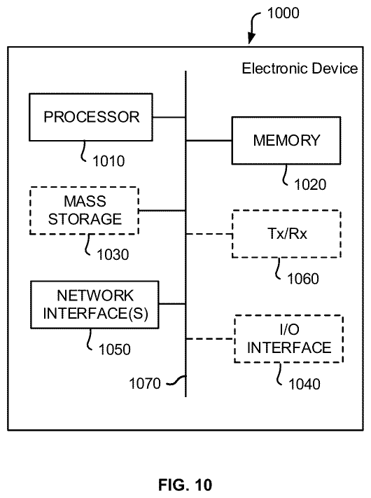

FIG. 10 is a schematic diagram of a communication apparatus 1000 that may be used in embodiments of the present disclosure as described herein. For example, APs, SMEs, STAs are all examples of communication apparatus. It is also noted that communication apparatus of the present disclosure may include microcontrollers or microprocessors which execute program instructions stored in memory, or other digital or analog circuitry, or a combination thereof.

As shown, the device includes a processor 1010, such as a Central Processing Unit (CPU) or specialized processors such as a Graphics Processing Unit (GPU) or other such processor unit, memory 1020, non-transitory mass storage 1030, I/O interface 1040, and network interface 1050, all of which are communicatively coupled via bi-directional bus 1070. According to certain embodiments, any or all of the depicted elements may be utilized, or only a subset of the elements. Further, the communication apparatus 1000 may contain multiple instances of certain elements, such as multiple processors, memories, or transceivers. Also, elements of the hardware device may be directly coupled to other elements without the bi-directional bus.

The memory 1020 may include any type of non-transitory memory such as static random access memory (SRAM), dynamic random access memory (DRAM), synchronous DRAM (SDRAM), read-only memory (ROM), any combination of such, or the like. The mass storage element 1030 may include any type of non-transitory storage device, such as a solid state drive, hard disk drive, a magnetic disk drive, an optical disk drive, USB drive, or any computer program product configured to store data and machine executable program code. According to certain embodiments, the memory 1020 or mass storage 1030 may have recorded thereon statements and instructions executable by the processor 1010 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any communication apparatus, and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

1. A method of configuring a multiple Access Points (M-AP) set, the method comprising:
transmitting, by an access point (AP) initiating a new M-AP set, an information element including a plurality of octets, one of the plurality of octets indicating the presence of an extended capabilities octet of the plurality of octets, the extended capabilities octet indicating if an M-AP Coordinated Transmissions (CT) Basic Service Set (BSS) is enabled for this AP.

2. The method of claim 1 wherein the enabling of the M-AP Coordinated Transmissions (CT) Basic Service Set (BSS) is indicated by a bit of the extended capabilities octet.

3. The method of claim 1 wherein the information element is included in a Beacon frame or in a Probe Response frame transmitted in the M-AP CT BSS.

4. The method of claim 1 wherein the Mesh Capability subfield which indicates the presence of the extended capabilities octet is encoded as a hexadecimal value 0×81.

5. The method of claim 2 wherein the bit is encoded as a 1 to indicate that M-AP CT feature is enabled.

6. The method of claim 1 wherein the information element further comprises a Mesh ID and an Authentication Protocol identifier.

7. The method of claim 1 wherein the information element further comprises any of:
a length,
an active path selection metric identifier,
an active path selection metric identifier,
a congestion control mode identifier,
a synchronization method protocol identifier,
a mesh formation information, or
a Mesh Capability.

8. The method of claim 1 wherein the mesh configuration element comprises an extended mesh capability sub-field.

9. The method of claim 2 wherein the extended mesh capability sub-field includes the bit which indicates the enabling of the M-AP CT BSS.

10. The method of claim 1 wherein the final octet comprises any of:
an accepting additional mesh peerings sub-field,
an MCCA supported sub-field,
an MCCA enabled sub-field,
a forwarding sub-field,
an MBCA enabled sub-field,
a TBBT adjusting sub-field,
a mesh power save level sub-field, or
an Extended Mesh Capability Present sub-field.

11. A method of establishing a multiple Access Points (M-AP) set between access points (APs), the method comprising:
transmitting, by a first AP, a first message advertising an M-AP Coordinated Transmission (CT) Basic Service Set (BSS);
receiving, by the first AP, from a second AP, a second message advertising a second M-AP CT BSS; and
initiate peering, in response to receiving the first message or the second message, used by an M-AP set including the first AP and the second AP.

12. The method of claim 11, further comprising receiving, by the first AP, from the second AP, a peering open message.

13. The method of claim 11, further comprising transmitting, by the first AP, to the second AP, a peering open message.

14. The method of claim 11 further comprising provisioning the M-AP set with security credentials.

15. The method of claim 11 wherein the provisioning of the M-AP set comprises:
transmitting, by the first AP, to the second AP, a Mesh Peering Open frame; and
receiving by the first AP, from the second AP, a Mesh Peering Confirm frame transmitted by the second AP in response to the second AP receiving the Mesh Peering Open frame.

16. A method for an access point (AP) to initiate establishment of a multiple Access Points (M-AP) set or to join an existing M-AP set, where the AP is part of a Multi Basic Service Set Identifier (MBSSID) set, the method comprising:
adding, by the AP, a subelement to a Multi Basic Service Set Identifier (MBSSID) element carried in a Beacon frame or a Probe Response frame transmitted in a transmitted BSSID of the MBSSID set, the subelement including a Mesh ID element and a Mesh configuration element containing the parameters of an M-AP Coordinated Transmission (CT) Basic Service Set (BSS).

17. The method of claim 16, wherein the subelement corresponds to a non-transmitted BSSID profile subelement, the non-transmitted BSSID profile subelement further including a non-inheritance element, the non-inheritance element including a list of element IDs, the list of element IDs including element ID values of the Mesh Configuration element and the Mesh ID element.

18. The method of claim 16, wherein the subelement corresponds to an M-AP CT BSS subelement, the M-AP CT BSS subelement including the Mesh configuration element, the Mesh ID element, and a MBSSID index list element, the MBSSID index list element including a list of nontransmitted BSSIDs corresponding to the MBSSID set that are also members of the exiting M-AP set.

19. The method of claim 18, wherein the transmitted BSSID which is a member of the M-AP set, will be indicated as Index 0 in the BSSID index list.
